(19) United States
(12) Patent Application Publication
(10) Pub. No.: US 2008/0063497 A1
(43) Pub. Date: Mar. 13, 2008

(54) Surface mounting system and method for a portable hoist assembly

(76) Inventor: Michael Spitsbergen, Escondido, CA (US)

Correspondence Address: STRASBURGER & PRICE, LLP, 901 MAIN STREET, SUITE 4400, DALLAS, TX, 75202, US

(21) Appl. No.: 11/900,793

(22) Filed: Sep. 13, 2007

Related U.S. Application Data
(60) Provisional application No. 60/844,324, filed on Sep. 13, 2006.

(51) Int. Cl. B60P 1/54

(52) U.S. Cl. 414/539; 212/179; 212/270

(57) ABSTRACT

A mounting system and method for a portable hoist assembly usable in the load-carrying portion of a vehicle includes a post base and a surface support base. The post base including a tubular support post and a plurality of support rings attached thereto. The surface support base includes a substantially flat plate having a hole formed therein with a receiver sleeve extending therefrom. The tubular support post of the post base is inserted into the receiver through the hole in the substantially flat plate. The portable hoist assembly is inserted through the plurality of support rings. Hardware is used to affix the surface support base to the floor of the load-carrying portion of the vehicle.

### CROSS-REFERENCE TO RELATED APPLICATION

This application claims the benefit of Provisional U.S. Patent Application 60/844,324 filed Sep. 13, 2006.

### STATEMENT REGARDING FEDERALLY-FUNDED RESEARCH AND DEVELOPMENT

The invention described in this patent application was not the subject of federally-sponsored researcher development.

### FIELD

The invention disclosed in this application is in the field of portable lifting devices; more particularly, the invention disclosed herein is a surface mounting system and method for a portable hoist assembly which enables utilization of the portable hoist assembly in the back of a truck, a van or other load-carrying vehicle.

### BACKGROUND

The ability to quickly and safely load and unload heavy or bulky items from the back of a delivery vehicle is vital to the operation of many businesses. Available floor space in a delivery vehicle may be at a premium. Hence, there is a need in the art for a system and method which will enable the use of a portable hoist assembly for heavy or bulky items in the load-carrying portion of a vehicle that does not take up precious load-carrying space when not in use.

In many situations, when there is a need to lift a heavy item into or out of the load-carrying space, two or more persons are needed. In other situations a ramp is used to either manually roll or slide a heavy object into or out of the load-carrying space of a vehicle. Neither of these two solutions offers an efficient use of time or force. In addition, these two solutions expose workers to the possibility of an injury.

To solve the problem of placing a heavy or bulky object into the load-carrying space of a vehicle, hydraulically-driven tailgate lift systems have been developed. These hydraulically-driven tailgate lift systems may be operated by a single person. When not in use the tailgate lift system folded either onto the back of a vehicle in a perpendicular orientation to the roadway or moved to a storage location under the vehicle. While effective, hydraulically-driven tailgate lift systems come with their own set of problems. First, hydraulically-driven tailgate lift systems are expensive and accordingly financially out of reach for most individuals and small businesses. Secondly, hydraulically-driven tailgate lift systems are themselves complex and heavy pieces of equipment that require both physical support and power from the vehicles on which they are mounted. Many inexpensive delivery or commercial vehicles simply do not have the necessary support structure or the available power to utilize a hydraulically-driven tailgate lift system.

In my U.S. Pat. No. 6,449,610B2 a simple, light weight portable hoist assembly is shown mounted in the bed of a pick-up truck. The vertical tube portion of the portable hoist assembly is shown mounted into a holster. The holster is shown mounted to both the floor and to the side wall of the bed of the pick-up truck. While effective, this holster-mounting system has been found not to be optimal for use in all vehicles. Specifically, the holster-mounting system disclosed in my U.S. Pat. No. 6,499,610B2 is problematic when floor space in the load-carrying portion of a vehicle is at a premium, when the side walls of the vehicle are not strong enough to mount the holster, and when the opening into the load-carrying portion of the vehicle cannot be restricted.

Accordingly, there remains a need in the art for a system and method to mount a portable hoist assembly in the back of a vehicle which does not use up valuable floor space, does not attach to the side walls of the load-carrying space and will not restrict the opening into the load-carrying portion of the vehicle.

### SUMMARY

The system and method of the present invention to mount a portable hoist assembly in the back of a vehicle does not use up floor space, does not require attachment to the side walls of the vehicle and does not restrict the opening into the load-carrying portion of the vehicle.

The disclosed system and method includes a post base and a surface support base. The post base provides for both the positioning and mounting of the vertical tube portion of a portable hoist assembly. The surface support base is mounted to the floor and/or floor supports which form the bottom of the load-carrying portion of the vehicle. Within the surface support system is a receiver sleeve into which the bottom portion of the post base is inserted. With the post base inserted into the surface support base, the vertical portion of the hoist assembly may be inserted into the two support rings which are attached to the vertical portion of the post base. The portable hoist assembly is now in position for use in lifting a heavy load located behind the vehicle and placing the heavy load into the load-carrying portion of the vehicle. Alternatively, the portable hoist assembly may be used to lift a heavy or bulky load from within the load-carrying portion of a vehicle and place it either behind or alongside the vehicle.

When the portable hoist assembly is no longer needed it can be removed from the post base and stored for future use. The post base may then be removed from the surface support base. All that remains is in the load-carrying portion of the vehicle is a flat plate mounted to the floor of the load-carrying portion of the vehicle.

### BRIEF DESCRIPTION OF THE DRAWING FIGURES

A better understanding of the surface mounting system and method for a portable hoist assembly made be had from the drawing figures wherein:

FIG. 1 is a perspective-exploded view of a kit used to provide a surface-mounting system for a portable hoist assembly in the back of a vehicle;

FIG. 2 is a perspective view of the surface support base portion of the disclosed invention shown in the load-carrying portion of a pick-up truck;

FIG. 3 is a perspective of the underside of a vehicle when the surface support base portion of the disclosed invention is mounted to the floor of a vehicle;

FIG. 4 is a perspective view similar to FIG. 2 with the post base inserted into the surface support base portion of the invention;

FIG. 5 is a perspective view similar to FIG. 4 with a portable hoist assembly inserted into the post base; and

FIG. 6 is a perspective view of the present invention together with a portable hoist assembly in the load-carrying portion of a small delivery van.

### DESCRIPTION OF THE EMBODIMENTS

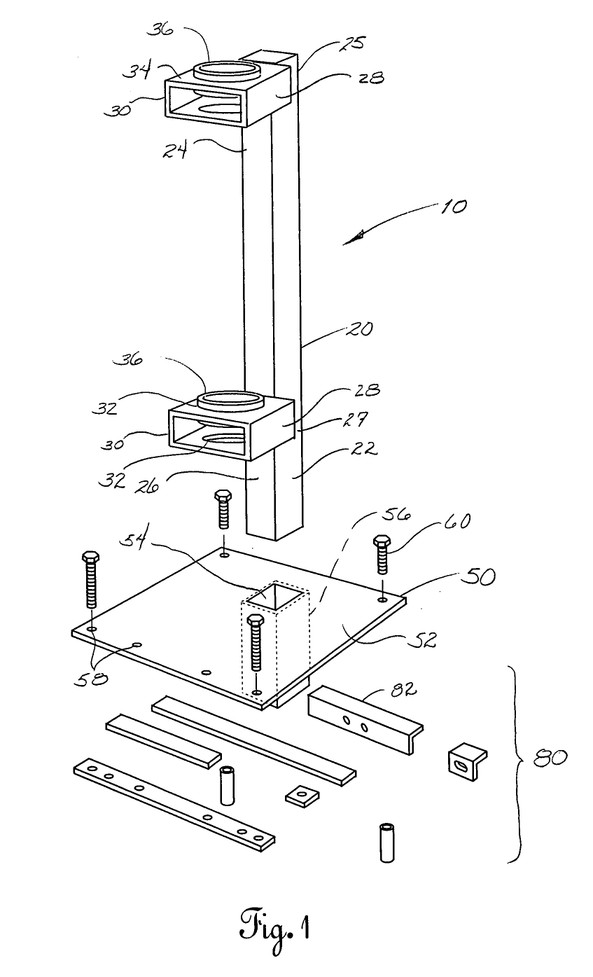

The system and method of the present invention 10, designed primarily for the mounting of a portable hoist assembly 100 is best understood by reference to FIG. 1. Therein it may be seen that the system and method of the present invention 10 includes three parts. These parts are the post base 20, the surface support base 50 and an array of mounting hardware 80.

The post base 20 includes three main parts. The first part is a substantially vertical tubular support post 22 having an upper portion 24 and a lower portion 26. Attached to the tubular support post 22 are two or more vertically-aligned, spaced apart, support rings 28. In the preferred embodiment the vertically-aligned support rings 28 are welded to be substantially perpendicular to the tubular support post 22, one ring being attached at the uppermost portion 25 of the upper portion 24 of the tubular support post 22 and the other ring being attached at the lowermost portion 27 of the upper portion 26 of the tubular support post 22.

In an alternate embodiment one or both of the vertically-aligned support rings 28 may be mechanically attached to the tubular support post 22. Such mechanical attachment may include a hinge whereby one or more of the support rings 28 may be moved from being substantially perpendicular to the tubular support post 22 to a position substantially parallel to the long axis of the tubular support post 22.

The vertically-aligned, spaced-apart, support rings 28 are formed from a flat piece of structural tubing 30. Holes 32 are bored through the side walls 34 of the structural tubing 30 to transform a section of the structural tubing 30 into a support ring 28. If desired a collar 36 may be placed in the hole 32 cut into the side walls 34 of the structural tubing 30. This collar 36 may be formed from a low friction material.

As may be further seen in FIG. 1 the substantially vertical tubular support post 22 also has a lower portion 26. It is the lower portion 26 which provides the mounting, the alignment and the resistance against a turnover moment when mated with the surface support base 50.

The surface support base 50 includes a substantially flat plate 52. Formed in the substantially flat plate 52 is an opening 54. The opening 54 is placed in the substantially flat plate 52 at a location where the rigidity of the substantially flat plate 52 will enable support for the post base 20 and resistance to a turnover moment when a portable hoist assembly 100 is placed within the support rings 28 of the post base 20. While a substantially flat plate 52 is used in the preferred embodiment, those of ordinary skill in the art will understand that plates having other shapes may be used.

Extending outwardly from the opening 54 in the substantially flat plate 52 is a receiver sleeve 56 for the tubular support post 22. The opening 54 and the receiver sleeve 56 are sized to allow for slidable interfitment with the lower portion 26 of the tubular support post 22 portion of the post base 20. The receiver sleeve 56 is typically welded to the bottom of the substantially flat plate 52. As may be seen in FIG. 1 a plurality of holes 58 are formed in the substantially flat plate 52. These holes 58 are sized to accommodate a plurality of threaded fasteners 60. The threaded fasteners 60 pass through the substantially flat plate 52 thence through various pieces of mounting hardware 80 which are used to attach the substantially flat plate 52 to the floor of the load-carrying portion of a vehicle 120. While a number of pieces of hardware 80 are shown in FIG. 1, the hardware actually used will depend on the design of the floor and the floor supports to which the surface support base 50 is mounted.

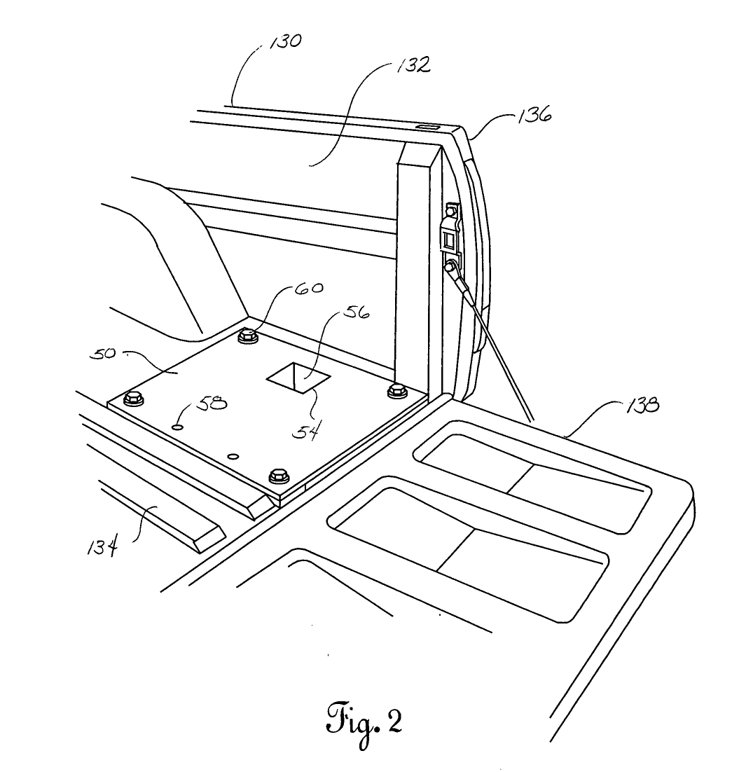

A complete mounting of the surface support base 50 to the floor portion 134 of the bed 132 of a pick-up truck 130 is shown in FIG. 2. Therein it may be seen that the threaded fasteners 60 extend through the substantially flat plate 52 to mount the surface support base 50 to the floor portion 134 of the bed 132 of the pick-up truck 130. Note that there is no need for mounting the surface support base 50 to the wall portion 136 extending upwardly from the floor 134 of the bed 132 of the pick-up truck 130. When a portable hoist assembly 100 is not in use a load may be placed on top 53 of the surface support base 50. In addition, as shown in FIG. 2, when the tailgate 138 of the pick-up truck 130 is open, the surface support base 50 does not block access to the bed 132 of the pick-up truck 130.

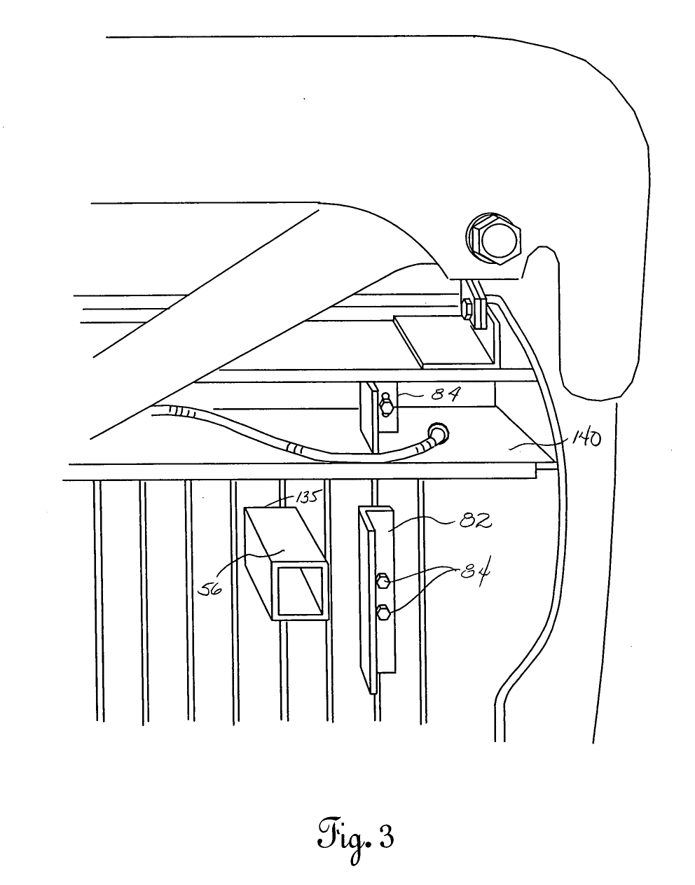

Further details regarding the mounting of the surface support base to the floor of the load-carrying portion of a vehicle are shown in FIG. 3, a perspective view looking upward from under the floor of the load-carrying portion of a vehicle. The receiver sleeve 56 is shown extending through a hole 135 cut through the floor of the load-carrying portion of the vehicle. Shown alongside the hole 135 is a piece of angle iron 82 which is mechanically connected by threaded fasteners 84 to the surface support base 50. Because many vehicles include cross panels 140 underneath the vehicle, it may be necessary to attach another piece of angle iron 84 for additional support of the surface support base 50.

As the present invention is made for use in a wide variety of vehicles, users may be supplied with a kit including numerous types of mounting pieces for enabling the mounting of the surface support base 50 in a variety of different vehicles. For vehicles having a floor of the load-carrying portion made from thin metal it is suggested that the surface support base 50 be connected to a floor support member. While hardware 80 has been used in the preferred embodiment for mounting the surface support base 50 to the floor of the load-carrying portion of the vehicle, it is also possible to weld the surface support base 50 in place.

In some special situations, even the presence of a substantially flat plate on the floor of the load-carrying portion of a vehicle may be objectionable. In these circumstances, it is also possible to mount the substantially flat plate 52 to the undersurface of the floor portion of the load-carrying portion of a vehicle. In this case a hole is cut through the floor which provides access to the opening 54 in the substantially flat plate 52 and to the receiver sleeve 56.

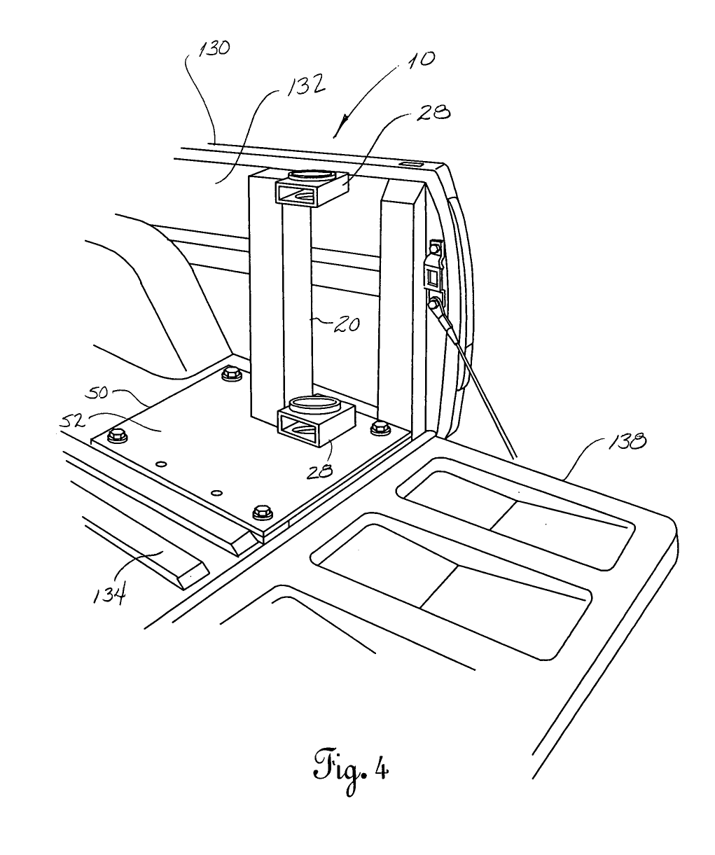

An assembled system 10 appears in FIG. 4. As described with respect to FIG. 2, the surface support base 50 is mounted to the floor 134 of the bed 132 of a pick-up truck 130. The lower portion 26 of the substantially vertical tubular support post 22 of the post base 20 has been inserted into the opening 54 in the substantially flat plate 52 and now resides in the receiver sleeve 56 beneath the substantially flat plate 52. This mounting of the surface support base 50 places the vertically-aligned support rings 28 in a position to receive the portable hoist assembly 100. If desired, the post base 20 may remain with the surface support base 50; however, many owners remove the post base 20 from the surface support base 50 to not take up space within the load-carrying area of the vehicle and to provide proper security for the post base 20 when not in use.

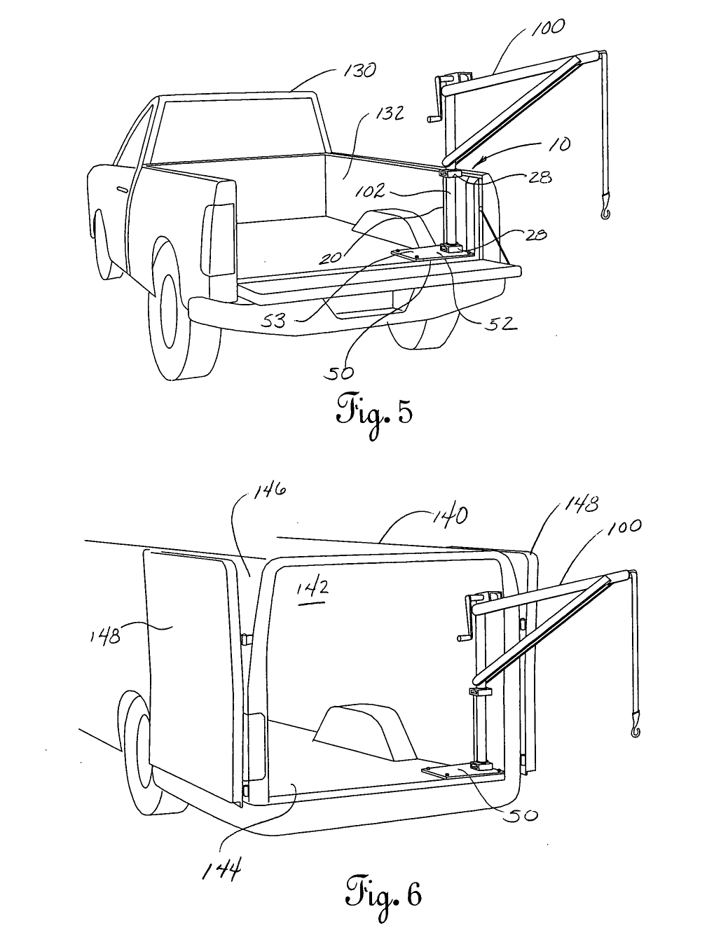

In FIG. 5, the system shown in FIG. 4 is shown together with a portable hoist assembly 100 such as the one described in my U.S. Pat. No. 6,499,610B2. The vertical portion 102 of the portable hoist assembly 100 is shown within each of the two support rings 28. The bottom of the vertical portion 102 of the portable hoist assembly 100 is shown resting on the top 53 substantially flat plate 52. Accordingly, the portable hoist assembly 100 can be turned in a full circle to pick up a heavy load from within the bed 132 of the pick-up truck 130, behind the pick-up truck 130 or alongside the pick-up truck 130. As previously indicated the opening 54 in the substantially flat plate 52 is located to resist a turn-over moment whether the heavy load is located within the bed of the pick-up truck 130, behind the pick-up truck 130 or alongside the pick-up truck 130.

Yet another application of the system of the present invention is shown in FIG. 6. Therein the system is shown mounted in a small enclosed delivery van 140. While mounting of the system of the present invention 10 in many types of vans is possible, it has been found that the system of the present invention 10 has particularly utility with small enclosed vans known as “Sprinter” vans. Such “Sprinter” vans are often used by plumbers, electricians or tradesmen who periodically carry heavy loads such as electric motors, valves, air conditioners and the like. The “Sprinter” vans are characterized by an enclosed load-carrying compartment 142 with sheet metal walls 146 that are not usable for support purposes. Accordingly, all support for a portable hoist system 100 must be provided by a floor mounting. While the system shown in the van 140 in FIG. 6 is only useful for lifting heavy or bulky loads located either within the enclosed load-carrying compartment 142 of the vehicle 140 or behind the vehicle 140, the mounting of the surface support base 50 to the floor 144 of the vehicle 140 provides the necessary resistance against a turnover moment. When the load has been lifted either into or out of the enclosed load-carrying compartment 142 of the van 140 the portable hoist assembly 100 is removed and the post base 20 is removed thereby restoring the load-carrying capacity of the van 140 and not blocking any part of the opening between the load-carrying compartment access doors 148.

While utilization of the present invention in the back of a pick-up truck 130 is shown in FIG. 5 and in the back of a van 140 is shown in FIG. 6, it will be understood that the system and method of the present invention may be used in a large van, on a stake or flatbed truck or on a trailer. It is also possible to use the system and method of the present invention on other vehicles such as boats or airplanes.

Those of ordinary skill in the art will understand that the method of the present invention begins with mounting the surface support base 50 to the floor of a vehicle. This is accomplished by selecting the location for the placement of the substantially flat plate 52. For U.S. vehicles, this location may be on the right side as this is the side closest to a curb. For non-U.S. vehicles, this location may be on the left side. Most users will want to mount the substantially flat plate 52 as close as possible to the side of the vehicle but at the same time not restricting the range of motion of the portable hoist system 100.

Once the location for the substantially flat plate 52 is chosen, a hole is cut in the floor of the load-carrying portion of the vehicle for insertion of the receiver sleeve 56. Following the insertion of the receiver sleeve 56 through the hole in the floor of the load-carrying portion of the vehicle, mounting hardware 80 such as shown in FIG. 1 is used to attach the surface support base 50 to either the floor of the vehicle or the floor supports beneath the vehicle. Such mounting has been previously described with respect to FIG. 3.

With the surface support base 50 in place, the lower portion 26 of the substantially vertical tubular support post 22 of the post base 20 may be inserted into both the opening 54 and the receiver sleeve 56 which extends therefrom in the substantially flat plate 52. Such insertion positions the vertically-aligned support rings 28 to where the vertical portion 102 of the portable hoist assembly 100 may be inserted. In most situations the lower support ring 28 will be in contact with the top 53 of the substantially flat plate 52. However, if desired a stop may be formed around the substantially vertical tubular support post 22.

With the post base 20 in place the portable hoist assembly 100 may be positioned within the post base 20 as shown in both FIG. 5 and in FIG. 6.

Disassembly begins with the removal of the portable hoist assembly 100 from the post base 20. Once removed the portable hoist assembly 100 may be folded up and stored for future use. Next comes the removal of the post base 20. As previously indicated, it may be possible to leave the post base 20 with the vehicle; however, some users may wish to remove the post base 20 from the vehicle to increase available space within or access to the load-carrying portion of the vehicle.

While the system and method of the present invention has been described according to its preferred and alternate embodiments, those of ordinary skills in the art will understand that numerous other embodiments have been enabled. Such other embodiments shall be included within the scope and meaning of the appended claims.

What is claimed is:

1. A surface-mounting system for the utilization of a portable hoist assembly in the load-carrying portion of a vehicle, said surface-mounting system comprising:
a post base, said post base including a substantially vertical tubular support post and a plurality of support rings attached to said tubular support post:
a surface support base, said surface support base including a substantially flat plate having an opening formed therein and a receiver sleeve extending in a substantially perpendicular manner from said opening;
mounting hardware for affixing said surface support base to the floor of the load-carrying portion of a vehicle.

2. The surface mounting system as defined in claim 1 wherein said support rings are formed using the side portion of a section of substantially tubing.

3. The surface mounting system as defined in claim 2 wherein said support rings include at least one collar for contacting the vertical portion of the portable hoist assembly.

4. The surface mounting system as defined in claim 3 wherein said at least one collar is formed from a low friction material.

5. The surface mounting system as defined in claim 1 wherein said surface support base is substantially rectangular and includes a plurality of holes formed therein to enable the use of said mounting hardware to affix said surface support base to the floor of the load-carrying portion of a vehicle.

6. A system for moving heavy loads either into or out of the load-carrying portion of a vehicle, said system comprising:
a portable hoist assembly said portable hoist assembly having a vertical support portion;
a surface-mounting system for said portable hoist assembly, said surface-mounting system including:
a post base, said post base including a substantially vertical tubular support post and a plurality of support rings attached to said tubular support post;
a surface support base, said surface support base including a substantially flat plate having an opening formed therein and a receiver sleeve extending from said opening; and
mounting hardware for affixing said surface support base to the floor of the load-carrying portion of a vehicle.

7. The system as defined in claim 6 wherein said support rings are formed from a section of substantially rectangular tubing.

8. The system as defined in claim 7 wherein said support rings include at least one collar for contacting said vertical support portion of said portable hoist assembly;

9. The system as defined in claim 8 wherein said at least one collar are formed from a low friction material.

10. The system as defined in claim 6 wherein said surface support base is substantially rectangular and includes a plurality of holes formed therein to enable the use of said mounting hardware to affix said surface support base to the floor of the load-carrying portion of a vehicle.

11. A post base for mounting a portable hoist assembly and for being inserted into a surface support base affixed to the floor of a vehicle, said post base comprising:
a substantially vertical support post;
a plurality of vertically-aligned support rings attached to said support post;
said substantially vertical support post having a lower portion constructed and arranged for insertion into said surface support base and an upper portion for spaced-apart attachment of said plurality of vertically-aligned support rings.

12. The post base as defined in claim 11 wherein said vertically-aligned support rings are formed using the side portions of a section of substantially flat tubing.

13. The post base as defined in claim 2 wherein said vertically-aligned support rings include at least one collar for contacting the vertical portion of a portable hoist assembly.

14. The post base as defined in claim 14 wherein said at least one collar is made from a low friction material.

15. The post base as defined in claim 11 wherein one of a said plurality of vertically-aligned support rings is attached to the uppermost portion of said upper portion of said substantially vertical support post.

16. A surface support base for mounting a post base in the load-carrying portion of a vehicle, said post base being used for the mounting and positioning of a portable hoist assembly, said surface support base comprising:
a substantially flat plate;
an opening formed within said substantially flat plate;
a tubular receiver sleeve extending outwardly from said opening in said substantially flat plate, said tubular receiver being constructed and arranged to pass through the floor of the load-carrying portion of the vehicle.

17. The surface support base as defined in claim 16 wherein said substantially flat plate includes mounting hardware to affix the surface support base to the floor of the load-carrying portion of the vehicle.

18. A method of mounting a system to the floor of the load-carrying portion of a vehicle for the utilization of a portable hoist system to either load or unload heavy or bulky objects from the load-carrying portion of a vehicle, said method comprising the steps of:
mounting a surface support base to the floor of the load-carrying portion of a vehicle, said surface support base having a substantially flat plate with a hole formed therein and a receiver sleeve extending outwardly from said hole;
inserting a post base into said surface support base, said post base including a support post and a plurality of support rings attached to said support post;
inserting the vertical portion of said portable hoist assembly through said plurality of vertical rings until it rests on said substantially flat plate;
whereby said portable hoist assembly may be used to load or unload or unload heavy or bulky objects from the load-carrying portion of a vehicle and removed from the vehicle along with said post base when not in use.

19. The method as defined in claim 19 wherein said vertical portion of said portable hoist assembly is rotatable with respect to said post base.

20. A delivery van comprising:
an enclosed load-carrying space including a floor;
at least one openable door to provide an access opening to said load-carrying space;
a system for moving heavy loads either into or out of said enclosed load-carrying space, said system including:
a portable hoist assembly, said portable hoist assembly having a vertical support portion;
a mounting system for affixing said portable hoist assembly to said floor, said mounting system including:
a post base, said post base including a substantially vertical tubular support post and a plurality of support rings attached to said tubular support post;
a surface support base, said surface support base including a substantially flat plate having an opening formed therein and a receiver sleeve extending from said opening;
mounting hardware for affixing said surface support base to said floor;
whereby when said portable hoist assembly is not in use said portable hoist assembly and said post base may be removed to not block said access opening to said load-carrying space.
